(19) United States
(12) Patent Application Publication
(10) Pub. No.: US 2015/0229765 A1
(43) Pub. Date: Aug. 13, 2015

(54) TELEPHONE DIRECTORY MANAGEMENT APPARATUS, TELEPHONE DIRECTORY MANAGEMENT SYSTEM, AND TELEPHONE DIRECTORY MANAGEMENT METHOD

(71) Applicant: BIGLOBE Inc., Tokyo (JP)

(72) Inventor: Kyoji Hirata, Tokyo (JP)

(73) Assignee: BIGLOBE Inc., Tokyo (JP)

(21) Appl. No.: 14/600,854

(22) Filed: Jan. 20, 2015

(30) Foreign Application Priority Data
Feb. 10, 2014 (JP) 2014-023645

(51) Int. Cl. H04M 3/493; H04W 4/16

(52) U.S. Cl. CPC H04M 3/4931; H04W 4/16

(57) ABSTRACT

To store voice information for identifying the voice of the opposite party in a telephone directory. A telephone directory management apparatus (100) according to a mode of the present invention is a telephone directory management apparatus (100) having telephone directory storage means (12) for storing a telephone number, and has registration means (24) for searching the telephone directory storage means (12) to check if a telephone number the same as the telephone number of the opposite party stored in call history storage means (11) for storing the telephone number of the opposite party and voice information for identifying the voice of the opposite party in an associated state is stored in the telephone directory storage means (12) and when a telephone number the same as the telephone number of the opposite party is stored in the telephone directory storage means (12), registering the voice information associated with the telephone number of the opposite party in the call history storage means (11) in a state of being associated with the telephone number the same as the telephone number of the opposite party in the telephone directory storage means (12).

This application is based upon and claims the benefit of priority from Japanese patent application No. 2014-023645, filed on Feb. 10, 2014, the disclosure of which is incorporated herein in its entirety by reference.

### BACKGROUND OF THE INVENTION

1. Field of the Invention

The present invention relates to a technology of managing a telephone directory constituted by telephone numbers and the like.

2. Related Art

In recent years, a criminal act of swindling money or other valuables by impersonating a family member such as a child or a grandchild and making a telephone call has been increasing and has become a social problem. Although the police and the like are urging people to take precautions, the criminal act is not readily decreased at present.

As a technology for preventing this kind of crime, for example, Japanese Patent Laid-Open Publication No. 2006-38955 (Patent Document 1) discloses a technology of preventing a swindle by using the voice print data of the opposite party.

According to Patent Document 1, the voice print data for identifying the opposite party is pre-registered in a voice print registration database. And at the time of a telephone call, the voice print data of the voice data of the opposite party is checked against the voice print data stored in the voice print registration database, and the result of the check is notified to the called party. Thereby, when the result of the check is that these pieces of voice print data coincide with each other, since the opposite party is a person registered in the voice print registration database, the called party can continue the telephone conversation without any worry. When the result of the check is that the pieces of voice print data do not coincide with each other, since the opposite party is not a person registered in the voice print registration database, when the opposite party is impersonating a person to which a piece of voice print data registered in the voice print registration database belongs, it can be determined that there is a possibility of a swindle.

### SUMMARY OF THE INVENTION

According to Patent Document 1, to register voice print data in the voice print registration database, a voice print data registration request is transmitted to a voice print authentication system by using a mobile telephone. When the registration request is accepted, the voice print authentication system establishes a call connection with the mobile telephone through which the voice print data is to be registered. Then, the voice print authentication system obtains the voice data of the opposite party, and registers the voice print data of the obtained voice data in the voice print registration database. For this reason, according to Patent Document 1, man-hours are required when the voice print data is registered in the voice print data registration database.

General telephones store a telephone directory, and by registering telephone numbers and names in the telephone directory in a state of being associated with each other, the name of the opposite party can be perceived at the time of a telephone call. Registering also the voice information for identifying the voice of the opposite party in this telephone directory is effective in preventing the above-mentioned impersonation swindle.

An object of the present invention is to store voice information for identifying the voice of the opposite party in a telephone directory.

A telephone directory management apparatus according to the present invention is a telephone directory management apparatus having telephone directory storage means for storing a telephone number, and has registration means for searching the telephone directory storage means to check if a telephone number the same as the telephone number of the opposite party stored in call history storage means for storing the telephone number of the opposite party and voice information for identifying the voice of the opposite party in an associated state is stored in the telephone directory storage means and when a telephone number the same as the telephone number of the opposite party is stored in the telephone directory storage means, registering the voice information associated with the telephone number of the opposite party in the call history storage means in a state of being associated with the telephone number the same as the telephone number of the opposite party in the telephone directory storage means.

According to the present invention, voice information for identifying the voice of the opposite party can be stored in the telephone directory.

### BRIEF DESCRIPTION OF THE DRAWINGS

FIG. 1 is a view showing an example of the structure of a telephone 100 of the present embodiment;

FIG. 2 is a view showing an example of the data structure of a call history storage portion 11;

FIG. 3 is a view showing an example of the data structure of a telephone directory storage portion 12;

FIG. 4 is a view showing an example of a call history screen;

FIGS. 5A and 5B are views showing an example of a telephone directory screen;

FIG. 6 is a view showing an example of the processing operation performed when voice print information is registered in the call history storage portion 11;

FIG. 7 is a first view showing an example of the processing operation performed when voice print information is registered in the telephone directory storage portion 12;

FIGS. 8A and 8B are views showing the examples of the processing operation performed when voice print information is registered in the telephone directory storage portion 12;

FIG. 9 is a view showing an example of the processing operation performed when a new telephone number is registered in the telephone directory storage portion 12;

FIG. 10 is a view showing an example of the processing operation performed when an additional telephone number is registered in the telephone directory storage portion 12;

FIG. 11 is a view showing an example of the processing operation performed when a telephone number in the telephone directory storage portion 12 is changed; and

FIG. 12 is a view showing an another structure example to realize the present embodiment.

### DESCRIPTION OF THE EMBODIMENTS

### (Overview of a Telephone Directory Management Apparatus According to a Mode of the Present Invention)

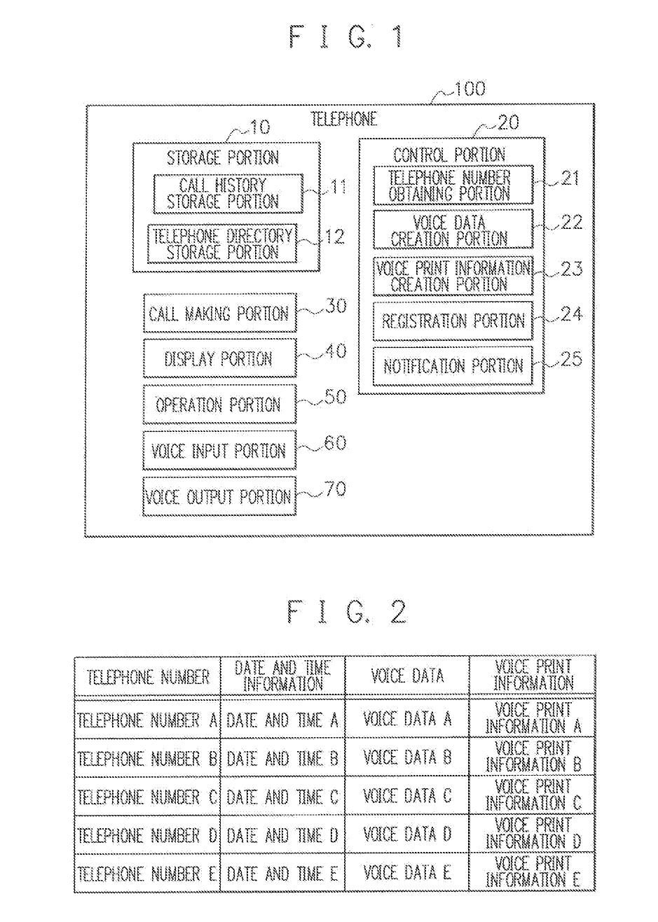

First, referring to FIG. 1, a telephone directory management apparatus according to a mode of the present invention will be described. FIG. 1 shows an example of the structure of the telephone directory management apparatus according to the mode of the present invention. An example of the telephone directory management apparatus is a telephone 100 shown in FIG. 1.

A telephone directory management apparatus according to the mode of the present invention is a telephone directory management apparatus having the telephone directory storage means for storing a telephone number.

The telephone directory management apparatus according to the mode of the present invention has the registration means.

The registration means searches the telephone directory storage means to check if a telephone number the same as the telephone number of the opposite party stored in the call history storage means for storing the telephone number of the opposite party and voice information for identifying the voice of the opposite party in an associated state is stored in the telephone directory storage means. When a telephone number the same as the telephone number of the opposite party is stored in the telephone directory storage means, the registration means registers the voice information associated with the telephone number of the opposite party in the call history storage means in a state of being associated with the telephone number the same as the telephone number of the opposite party in the telephone directory storage means.

The call history storage means stores the telephone number of the opposite party and voice information for identifying the voice of the opposite party in an associated state. For this reason, in the telephone directory management apparatus according to the mode of the present invention, the telephone directory storage means is searched to check if the telephone number the same as the telephone number of the opposite party stored in the call history storage means is stored in the telephone directory storage means. When a telephone number the same as the telephone number of the opposite party is stored in the telephone directory storage means, the voice information associated with the telephone number of the opposite party in the call history storage means is registered in a state of being associated with the telephone number the same as the telephone number of the opposite party in the telephone directory storage means.

Thereby, in the telephone directory management apparatus according to the mode of the present invention, the voice information for identifying the voice of the opposite party can be efficiently stored in the telephone directory. As the voice information stored in both the call history storage means and the telephone directory storage means, one voice information file may be shared in a logically associated state between these storage means, or one voice information file may be stored in each of the storage means. However, in the case where one voice information file is shared between the storage means, when a prescribed time, or a prescribed number of stored files or storage capacity is exceeded and an old call history is deleted in the call history storage means, the voice information stored also in the telephone directory storage means is not deleted. Moreover, the voice information is not specifically limited as long as it can identify the voice of the opposite party; for example, voice data that is a digital file into which a voice uttered by the opposite party is converted or voice print information created based on the voice data may be used. Hereinafter, the telephone directory management apparatus according to the mode of the present invention will be described in detail with reference to the attached drawings. In the following embodiment, description will be given with a telephone 100 as an example of the telephone directory management apparatus and with voice print information as an example of the voice data. Moreover, description will be given with a call history storage portion 11 as an example of the call history storage means, with a telephone directory storage portion 12 as an example of the telephone directory storage means, with a registration portion 24 as an example of the registration means and with a notification portion 25 as an example of the notification means.

### First Embodiment

### <Example of the Structure of the Telephone 100>

First, referring to FIG. 1, an example of the structure of the telephone 100 of the present embodiment will be described. FIG. 1 is a view showing the example of the structure of the telephone 100 of the present embodiment. The telephone 100 corresponds to various apparatuses having a telephone function such as a fixed-line telephone, a mobile telephone and a smartphone.

The telephone 100 of the present embodiment is provided with: a storage portion 10, a control portion 20, a call making portion 30, a display portion 40, an operation portion 50, a voice input portion 60 and a voice output portion 70.

The storage portion 10 stores various pieces of information. The control portion 20 controls the telephone 100. The call making portion 30 establishes a call connection with a telephone of the opposite party to enable a telephone call with the opposite party. The display portion 40 displays the telephone number of the opposite party, various operation contents, various alerts and the like. The display portion 40 is formed of, for example, a display. The operation portion 50 inputs various pieces of information used when the telephone 100 is operated. Moreover, it inputs telephone numbers and names. The operation portion 50 is structured, for example, in the form of buttons such as switches or in the form of a touch panel such as icons displayed on the display portion 40. The voice input portion 60 inputs a voice. The voice input portion 60 is formed of, for example, a microphone. The voice output portion 70 outputs a voice. The voice output portion 70 is formed of, for example, a speaker.

The storage portion 10 of the present embodiment has the call history storage portion 11 and the telephone directory storage portion 12.

The call history storage portion 11 stores the telephone number in the call history in a state of being associated with the voice print information. As shown in FIG. 2, the call history storage portion 11 of the present embodiment stores a telephone number, date and time information, voice data and voice print information in an associated state. The telephone number is the telephone number of the opposite party. In the present embodiment, the telephone number of the opposite party is the telephone number obtained when a call connection is established between the telephone 100 and the telephone of the opposite party, and includes the telephone number obtained from an answering machine. The date and time information is information for identifying the date and time of a telephone call. In the present embodiment, as the call history, telephone numbers and date and time information are stored in the call history storage portion 11. However, the call history is not limited only to telephone numbers and date and time information, and various pieces of information that can be obtained when a call connection is established between the telephone 100 and the telephone of the opposite party may be stored in the call history storage portion 11 as the call history. The voice data is voice data that is a digital file into which a voice uttered by the opposite party at the time of a telephone call or in a message left on the answering machine is converted. The voice print information is information for uniquely identifying the opposite party and is information created based on the voice data. The opposite party can also be identified by the voice data. The call history storage portion 11 may be provided more than one in number so as to be divided into one for incoming calls and one for outgoing calls. Moreover, the incoming call history and the outgoing call history may be managed by one portion. Moreover, the voice data may be deleted after the voice print information is created.

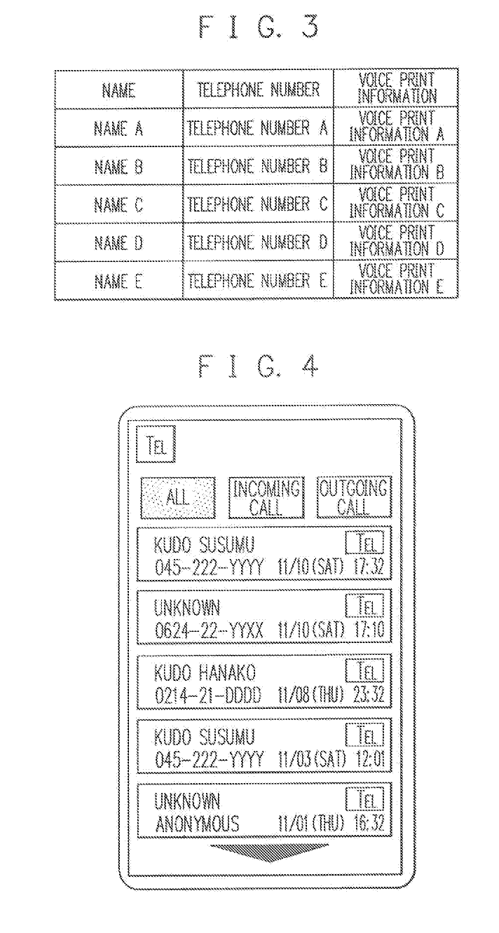

The telephone directory storage portion 12 stores a telephone directory constituted by telephone numbers and the like. As shown in FIG. 3, the telephone directory storage portion 12 of the present embodiment stores names, telephone numbers and voice print information in an associated state. In the telephone directory storage portion 12, information such as addresses, mail addresses and photographs may be stored.

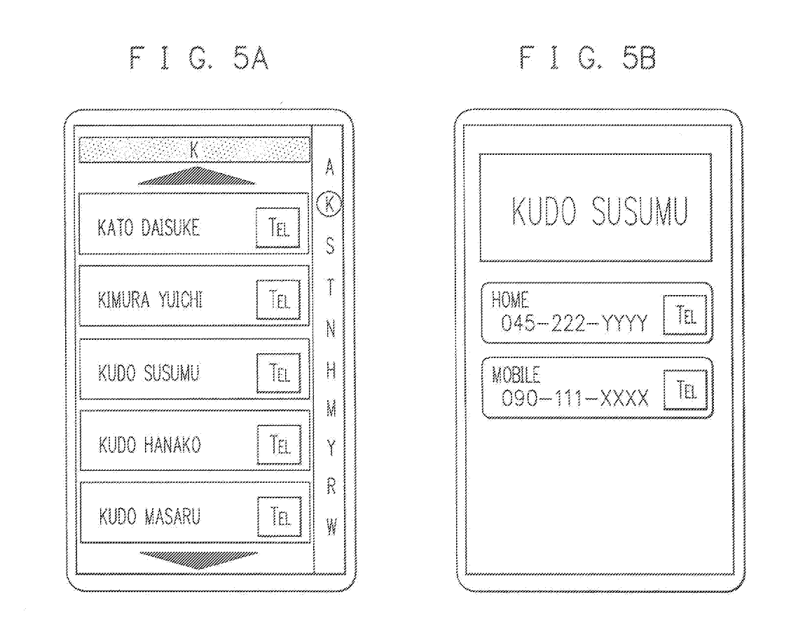

The telephone 100 of the present embodiment which has the call history storage portion 11 and the telephone directory storage portion 12 is capable of displaying the call history screen shown in FIG. 4 and the telephone directory screen shown in FIGS. 5A and 5B on the display portion 40 by using the information stored in the call history storage portion 11 and the telephone directory storage portion 12. FIG. 4 shows an example of the call history screen, and FIGS. 5A and 5B show an example of the telephone directory screen.

As shown in FIG. 2, the call history storage portion 11 of the present embodiment stores telephone numbers and date and time information as the call history. For this reason, the telephone numbers and the date and time information can be displayed like the call history screen shown in FIG. 4. As the names displayed on the call history screen, when the telephone numbers in the call history are stored in the telephone directory storage portion 12, the names corresponding to the telephone numbers stored in the telephone directory storage portion 12 are displayed on the call history screen.

As shown in FIG. 3, the telephone directory storage portion 12 of the present embodiment stores telephone numbers and names. For this reason, the names and the telephone numbers corresponding to the names can be displayed like the telephone directory screen shown in FIGS. 5A and 5B. FIG. 5A shows an example in which a list of names the family names of which start with “ka”, “ki”, “ku”, “ke” and “ko” and that are stored in the telephone directory storage portion 12 is displayed, and FIG. 5B shows an example in which two telephone numbers of the home telephone and the mobile telephone associated with “KUDO Susumu” are displayed.

The control portion 20 of the present embodiment has a telephone number obtaining portion 21, a voice data creation portion 22, a voice print information creation portion 23, the registration portion 24 and the notification portion 25.

The telephone number obtaining portion 21 obtains the telephone number of the opposite party, and registers it in the call history storage portion 11 in a state of being associated with the date and time information. The telephone number obtaining method is not specifically limited, and the telephone number may be obtained by an arbitrary method. For example, the telephone number obtaining portion 21 obtains the telephone number when a telephone call is received or made. However, when the opposite party is anonymous or the like, since the telephone number cannot be obtained, the telephone number is set as anonymous in the call history storage portion 11.

The voice data creation portion 22 obtains the voice data of the opposite party, and registers it in the call history storage portion 11 in a state of being associated with the telephone number. The voice data can be obtained by recording the voice of the opposite party during the telephone conversation. It can also be obtained by recording the voice of the opposite party recorded by the answering machine.

The voice print information creation portion 23 creates voice print information by which the opposite party can be uniquely identified, based on the voice data registered in the call history storage portion 11, and registers it in the call history storage portion 11 in a state of being associated with the telephone number. The voice print information creating method is not specifically limited, and the voice print information can be created by an arbitrary method.

The voice print information includes feature amounts attributable to anatomical features such as the sizes and shapes of the throat and the mouth including the pitch and the frequency characteristic and feature amounts attributable to the environment such as the speaking speed and style, and can be created by extracting it from part or the whole of the voice data. Moreover, the voice print information can also be created by predetermining a word or a sentence used for the voice print information, extracting the predetermined word or sentence from the voice data and creating the voice print information based on the extracted word or sentence.

The registration portion 24 registers various pieces of information in the telephone directory storage portion 12 and edits the pieces of information stored in the telephone directory storage portion 12. For example, the registration portion 24 newly registers a telephone number in the telephone directory storage portion 12. Moreover, the registration portion 24 adds a new telephone number to an already stored telephone number. Moreover, the registration portion 24 changes a telephone number already stored in the telephone directory storage portion 12 to a different one.

The notification portion 25 outputs various alerts and notifies them to the user. The alerts are, for example, information indicating to the user the contents of attention and alerts and the explanations of the current status, and a voice of the alert contents or an alert sound is outputted from the voice output portion 70 and notified to the user or a display of the alert contents or a mark corresponding to the alert contents is outputted to the display portion 40 and notified to the user.

### <Examples of the Processing Operation of the Telephone 100 of the Present Embodiment>

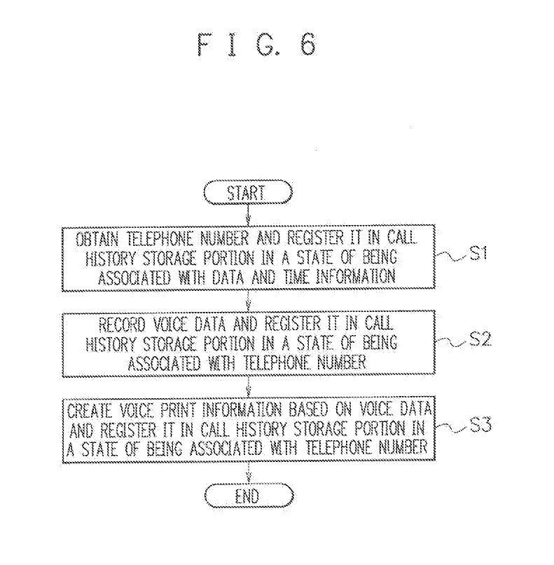

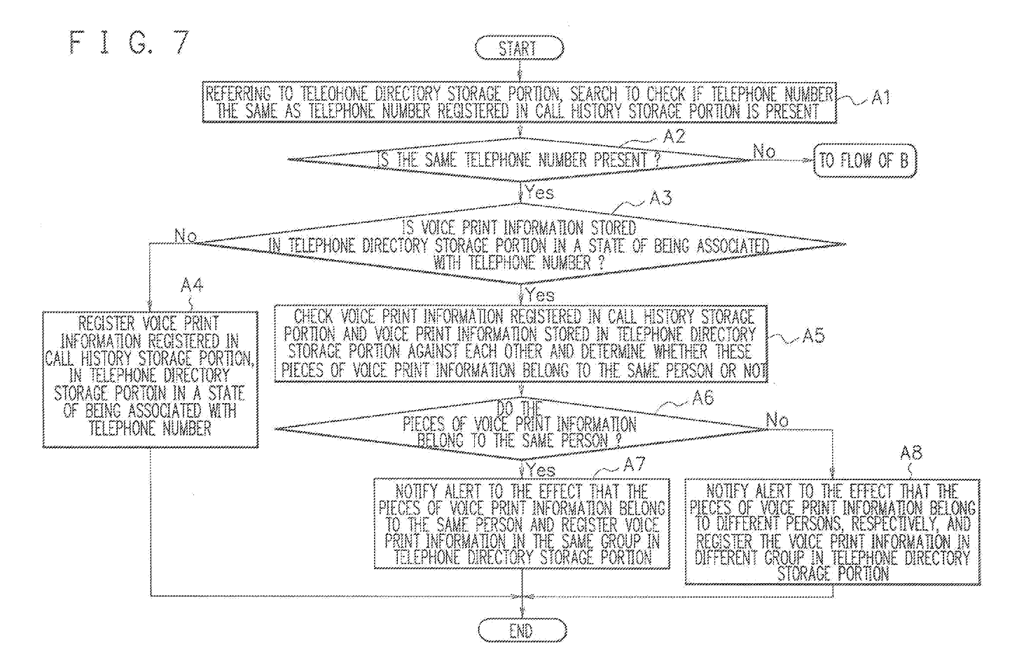

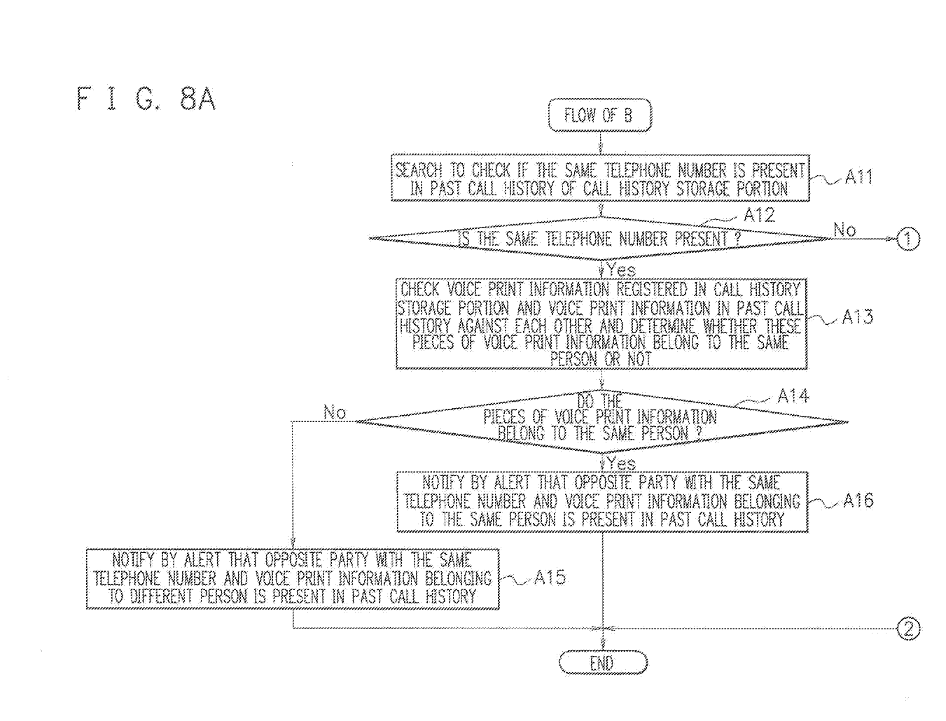

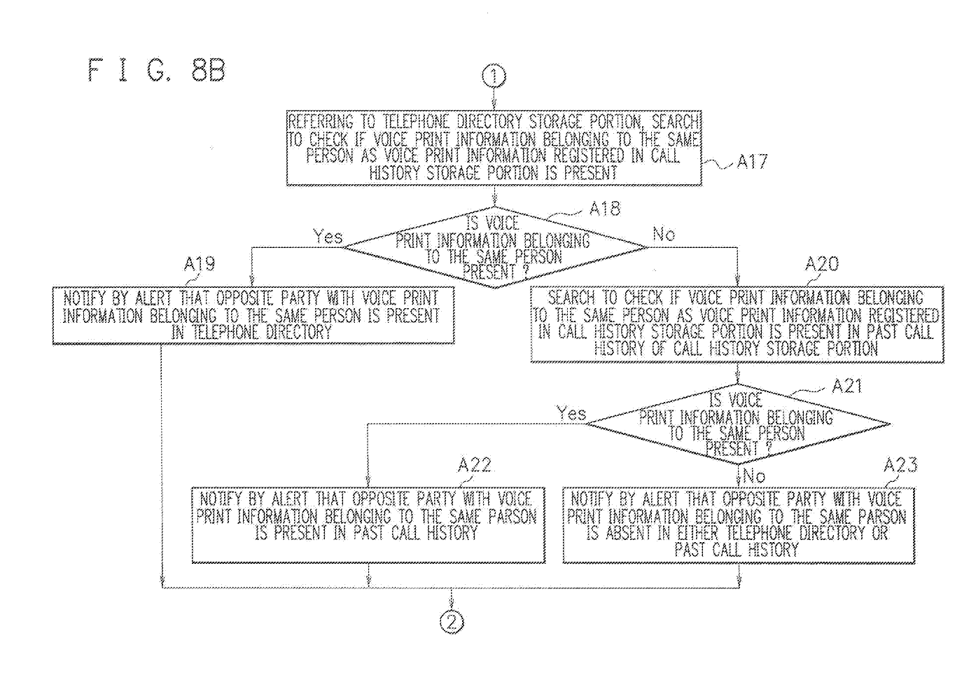

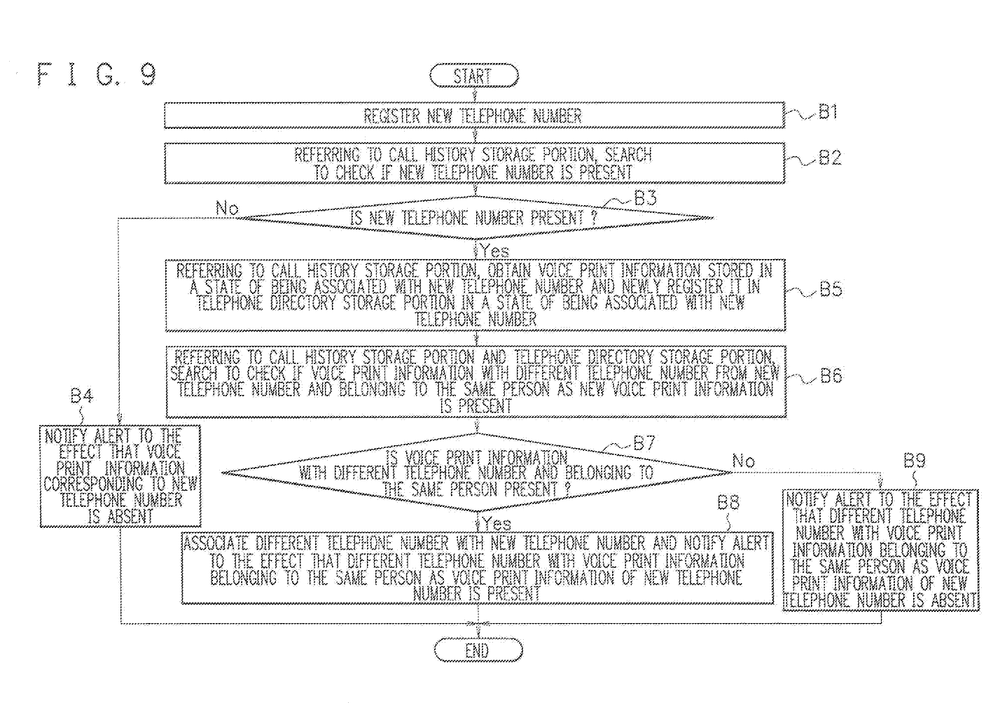

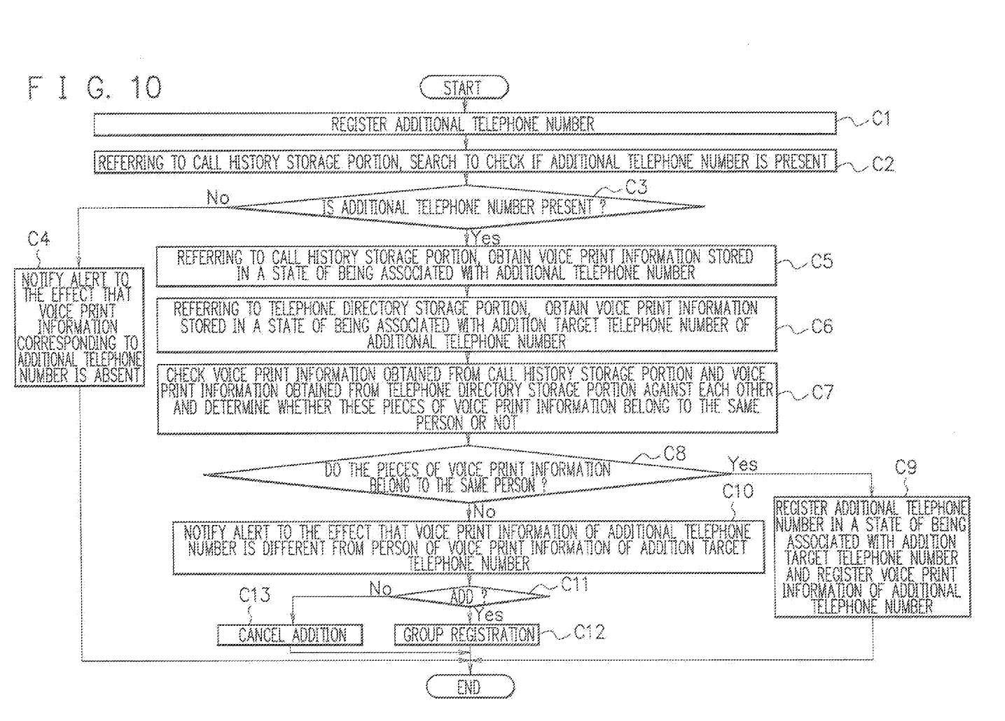

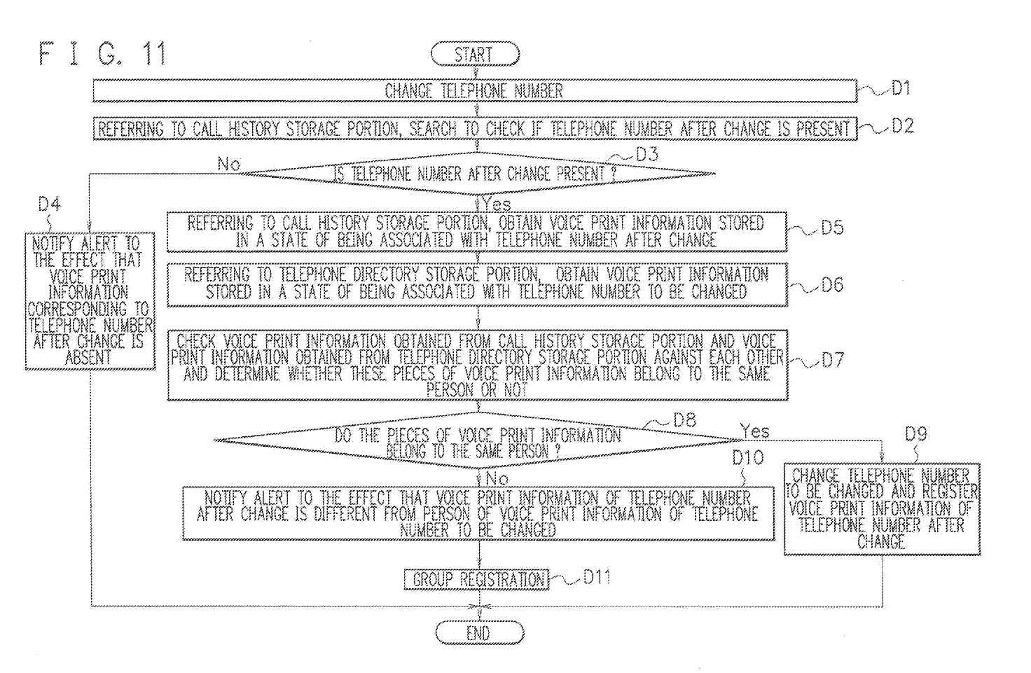

Next, referring to FIGS. 6 to 11, examples of the processing operation of the telephone 100 of the present embodiment will be described. FIG. 6 is a view showing an example of the processing operation performed when voice print information is registered in the call history storage portion 11. FIGS. 7 and 8A and 8B are views showing an example of the processing operation performed when the voice print information registered in the call history storage portion 11 is registered in the telephone directory storage portion 12. FIG. 9 is a view showing an example of the processing operation performed when a new telephone number is registered in the telephone directory storage portion 12. FIG. 10 is a view showing an example of the processing operation performed when an additional telephone number is registered in the telephone directory storage portion 12. FIG. 11 is a view showing an example of the processing operation performed when a telephone number in the telephone directory storage portion 12 is changed.

<Example of the Processing Operation Performed when Voice Print Information is Registered in the Call History Storage Portion 11>

First, referring to FIG. 6, an example of the processing operation performed when voice print information is registered in the call history storage portion 11 will be described. The example of the processing operation of FIG. 6 will be described by using as an example the processing operation performed when a telephone call is received. This processing operation may be performed when a telephone call is made.

When a telephone call arrives at the telephone 100 and the telephone 100 establishes a call connection with the telephone of the opposite party, a telephone call is started with the telephone of the opposite party.

At this time, the telephone number obtaining portion 21 obtains the telephone number of the opposite party, and registers it in the call history storage portion 11 in a state of being associated with the information on the date and time of the arrival of the telephone call (step S1).

Moreover, the voice data creation portion 22 records the voice data of the opposite party, and registers it in the call history storage portion 11 in a state of being associated with the telephone number in the call history (step S2). The voice data is registered in the call history storage portion 11 concurrently with the telephone conversation or registered in the call history storage portion 11 when the telephone conversation is ended.

Then, the voice print information creation portion 23 creates voice print information based on the voice data registered in the call history storage portion 11, and registers it in the call history storage portion 11 in a state of being associated with the telephone number in the call history (step S3). The voice print information creating method is not specifically limited, and the voice print information can be created by an arbitrary method. The voice print information creation portion 23 may create voice print information, for example, based on the voice data with the latest date and time information in the call history storage portion 11 and register the created voice print information in the call history storage portion 11. Moreover, the voice print information creation portion 23 may create voice print information based on voice data registered in the call history storage portion 11 in a state of being associated with no voice print information and register the created voice print information in the call history storage portion 11.

Thereby, the call history storage portion 11 is capable of storing telephone numbers, date and time information, voice data and voice print information in an associated state.

<Example of the Processing Operation Performed when Voice Print Information is Registered in the Telephone Directory Storage Portion 12>

Next, referring to FIGS. 7 and 8A and 8B, an example of the processing operation performed when voice print information is registered in the telephone directory storage portion 12 will be described. When the telephone 100 performs the processing operation shown in FIG. 6 and voice print information is registered in the call history storage portion 11, the registration portion 24 starts the processing shown in FIG. 7.

First, referring to the telephone directory storage portion 12, the registration portion 24 searches the telephone directory storage portion 12 to check if a telephone number the same as a telephone number registered in the call history storage portion 11 in the processing shown in FIG. 6 is present (step A1).

When the same telephone number is present (step A2/Yes), it is determined whether voice print information is stored in the telephone directory storage portion 12 in a state of being associated with the telephone number or not (step A3). When voice print information is not stored in the telephone directory storage portion 12 (step A3/No), the voice print information registered in the call history storage portion 11 is registered in the telephone directory storage portion 12 in a state of being associated with the telephone number (step A4), and the process is ended (End). Thereby, the telephone 100 of the present embodiment is capable of automatically registering the voice print information registered in the call history storage portion 11 in the telephone directory storage portion 12.

When the voice print information is stored in the telephone directory storage portion 12 in a state of being associated with the telephone number (step A3/Yes), the voice print information registered in the call history storage portion 11 and the voice print information stored in the telephone directory storage portion 12 are checked against each other, and it is determined whether these pieces of voice print information belong to the same person or not (step A5). The determination as to whether these pieces of voice print information belong to the same person or not is made by, for example, checking the similarity between these pieces of voice print information or checking the coincidence of the characteristic portions of these pieces of voice print information. When the result of the check is that these pieces of voice print information belong to the same person (step A6/Yes), the notification portion 25 notifies an alert to the effect that these pieces of voice print information belong to the same person. Then, the registration portion 24 registers the voice print information registered in the call history storage portion 11, in the same group as that of the voice print information already stored in the telephone directory storage portion 12 (step A7). Examples of the alert include an alert such as “Voice print information belonging to *** (indicating the name stored in the telephone directory storage portion 12 in a state of being associated with the telephone number) is newly added to the telephone directory”. When these pieces of voice print information belong to the same person, it is possible not to register the voice print information registered in the call history storage portion 11, in the telephone directory storage portion 12. However, by registering the voice print information registered in the call history storage portion 11, in the telephone directory storage portion 12 even when the pieces of voice print information belong to the same person, the accuracy of the voice print information check can be further increased since the number of voice print information samples is increased. The registration of the voice print information in the telephone directory storage portion 12 performed at step A7 may be performed by notifying to the user an alert such as “Newly add voice print information of *** to the telephone directory?” and then, registering the voice print information in the telephone directory storage portion 12 when a voice print information registration request is accepted by a user operation from the operation portion 50 or the like.

When the result of the check is that these pieces of voice print information do not belong to the same person (step A6/No), the notification portion 25 notifies an alert to the effect that these pieces of voice print information belong to different persons, respectively. Then, the registration portion 24 registers the voice print information registered in the call history storage portion 11, in a group different from that of the voice print information already stored in the telephone directory storage portion 12 (step A8). Examples of the alert include an alert such as “Voice print information belonging to a person different from *** (indicating the name stored in the telephone directory storage portion 12 in a state of being associated with the telephone number) is newly added to the telephone directory”. The registration of the voice print information in the telephone directory storage portion 12 performed at step A8 may be performed by notifying to the user an alert such as “Register voice print information belonging to a person different from the voice print information belonging to *** in the telephone directory?” and then, registering the voice print information in the telephone directory storage portion 12 when a voice print information registration request is accepted by a user operation from the operation portion 50 or the like.

In the present embodiment, when the pieces of voice print information belong to different persons, respectively, the voice print information registered in the call history storage portion 11 is registered in a group different from that of the voice print information already stored in the telephone directory storage portion 12. Thereby, with respect to one telephone number, pieces of voice print information divided into a plurality of groups can be managed in the telephone directory storage portion 12 in an associated state. For example, a home telephone number is used by a plurality of persons such as the father, the mother and children. For this reason, there are cases where different persons make telephone calls from one common telephone number. In the present embodiment, with respect to one telephone number, pieces of voice print information divided into a plurality of groups are managed in the telephone directory storage portion 12 in an associated state. For this reason, even for one common telephone number, by performing the check by using the voice print information, whether the father is calling, whether the mother is calling or whether a child is calling can be identified. However, for person identification, a user operation of registering a name for each group is required.

When a telephone number the same as a telephone number registered in the call history storage portion 11 is absent in the telephone directory storage portion 12 at step A2 (step A2/No), the process shifts to the flow shown in FIGS. 8A and 8B. Then, the past call history of the call history storage portion 11 (indicating a call history other than the call history of the telephone number registered by the flow of FIG. 6) is searched to check if the same telephone number is present (step A11).

When the same telephone number is present in the past call history (step A12/Yes), the voice print information registered in the call history storage portion 11 and the voice print information associated with the same telephone number in the past call history are checked against each other, and it is determined whether these pieces of voice print information belong to the same person or not (step A13). When the result of the check is that these pieces of voice print information do not belong to the same person (step A14/No), the notification portion 25 provides notification by an alert that an opposite party with the same telephone number and voice print information belonging to a different person is present in the past call history (step A15). Examples of the alert include an alert such as “The opposite party (indicating the opposite party of the telephone call in the flow of FIG. 6) is an opposite party with the same telephone number as that at the time of the telephone call on *** (indicating the date and time information stored in the call history storage portion 11) in the past call history and voice print information of a person different from the opposite party at that time”.

When the result of the check is that these pieces of voice print information belong to the same person (step A14/Yes), the notification portion 25 provides notification by an alert that an opposite party with the same telephone number and voice print information belonging to the same person is present in the past call history (step A16). Examples of the alert include an alert such as “The opposite party (indicating the opposite party of the telephone call in the flow of FIG. 6) is an opposite party with the same telephone number as that at the time of the telephone call on *** (indicating the date and time information stored in the call history storage portion 11) in the past call history and voice print information of the same person as the opposite party at that time”.

When the same telephone number is absent in the past call history of the call history storage portion 11 at step Al2 (step Al2/No), referring to the telephone directory storage portion 12, the telephone directory storage portion 12 is searched to check if voice print information belonging to the same person as the voice print information registered in the call history storage portion 11 is present (step A17). When the voice print information belonging to the same person is present in the telephone directory storage portion 12 (step A18/Yes), the notification portion 25 provides notification by an alert that an opposite party with voice print information belonging to the same person is present in the telephone directory (step A19). Examples of the alert include an alert such as “The opposite party (indicating the opposite party of the telephone call in the flow of FIG. 6) is an opposite party with the voice print information belonging to the same person as the voice print information of *** (indicating the name stored in the telephone directory storage portion 12 in a state of being associated with the voice print information) registered in the telephone directory”.

When the voice print information belonging to the same person is absent in the telephone directory storage portion 12 at step A18 (step A18/No), referring to the call history storage portion 11, the call history storage portion 11 is searched to check if the voice print information belonging to the same person is present in the past call history (step A20). When the voice print information belonging to the same person is present in the past call history (step A21/Yes), the notification portion 25 provides notification by an alert that an opposite party with the voice print information belonging to the same person is present in the past call history (step A22). Examples of the alert include an alert such as “The opposite party (indicating the opposite party of the telephone call in the flow of FIG. 6) is an opposite party not registered in the telephone directory and with the voice print information belonging to the same person as the voice print information at the time of the telephone call on *** (indicating the date and time information stored in the call history storage portion 11) in the past call history”.

When the voice print information belonging to the same person is absent in the past call history (step A21/No), the notification portion 25 provides notification by an alert that an opposite party with the voice print information belonging to the same person is absent in either the telephone directory or the past call history (step A23). Examples of the alert include an alert such as “The opposite party (indicating the opposite party of the telephone call in the flow of FIG. 6) is an opposite party the voice print information of which is absent in either the telephone directory or the past call history”.

<Example of the Processing Operation Performed when a New Telephone Number is Registered in the Telephone Directory Storage Portion 12>

Next, referring to FIG. 9, an example of the processing operation performed when a new telephone number is registered in the telephone directory storage portion 12 will be described.

When a new registration request for registering a new telephone number in the telephone directory storage portion 12 is accepted (step B1), referring to the call history storage portion 11, the registration portion 24 performs search to check if a new telephone number the request for new registration of which is accepted is present in the call history storage portion 11 (step B2). The new registration request occurs, for example, when the user operates the operation portion 50 or the like to perform a registration request operation for newly registering a telephone number in the call history, in the telephone directory storage portion 12. Moreover, it occurs when the user inputs a new telephone number by operating the operation portion 50 or the like and performs a registration request operation for newly registering the inputted new telephone number in the telephone directory storage portion 12.

When the new telephone number the request for new registration of which is accepted is absent in the call history storage portion 11 (step B3/No), the notification portion 25 notifies an alert to the effect that the voice print information corresponding to the new telephone number is absent (step B4). This alert occurs when a new registration request to register a new telephone number that is absent in the call history is made at step B1. Even when the new telephone number is absent in the call history storage portion 11, the user can register the new telephone number and the name in the telephone directory storage portion 12 by operating the operation portion 50. In this case, the name and the telephone number are registered in the telephone directory storage portion 12 in an associated state.

When the new telephone number the request for new registration of which is accepted is present in the call history storage portion 11 (step B3/Yes), referring to the call history storage portion 11, the voice print information associated with the new telephone number is obtained from the call history storage portion 11. Then, the obtained voice print information is newly registered in the telephone directory storage portion 12 in a state of being associated with the new telephone number (step B5). When a plurality of pieces of voice print information associated with the new telephone number are obtained from the call history storage portion 11, the pieces of voice print information are checked against each other, sorted into groups of pieces of voice print information determined to belong to the same persons, and registered in the groups. For example, when it is determined that all the pieces of voice print information belong to the same person, all the pieces of voice print information are registered in one group. Moreover, when the pieces of voice print information determined to belong to the same person are sorted into two, the pieces of voice print information are sorted into two groups and registered.

Then, referring to the call history storage portion 11 and the telephone directory storage portion 12, the registration portion 24 performs search to check if voice print information with a telephone number different from the new telephone number newly registered in the telephone directory storage portion 12 and belonging to the same person as the new voice print information newly registered in the telephone directory storage portion 12 is present in the call history storage portion 11 and the telephone directory storage portion 12 (step B6). When the result of the search is that voice print information with a telephone number different from the new telephone number and belonging to the same person as the new voice print information is present (step B7/Yes), the different telephone number is obtained from the call history storage portion 11 and the telephone directory storage portion 12. Then, the obtained different telephone number is associated with the new telephone number, and the notification portion 25 notifies an alert to the effect that a different telephone number with voice print information belonging to the same person as the voice print information of the new telephone number is present (step B8). Thereby, the user using the telephone 100 can perceive the presence of the different telephone number with the voice print information belonging to the same person as the voice print information of the new telephone number newly registered in the telephone directory storage portion 12.

For example, it is assumed that a user A makes a telephone call to the telephone 100 from an office telephone number and a home telephone number. In this case, in the call history storage portion 11, the office telephone number and the home telephone number are registered in a state of being associated with the voice print information belonging to the same user A. When the user using the telephone 100 newly registers the office telephone number of the user A in the telephone directory storage portion 12 under this condition, he/she can perceive, for example by the display portion 40, the presence of the home telephone number of the user A with the voice print information belonging to the same person as the voice print information of the office telephone number. In addition to displaying the different telephone number on the display portion 40 in a state of being associated with the new telephone number, the different telephone number may be registered in the telephone directory storage portion 12 in a state of being associated with the new telephone number. This registration may be automatically performed or may be performed by a user operation. When a different telephone number is registered in a state of being associated with a new telephone number, the new telephone number becomes a main telephone number, whereas the different telephone number becomes a sub telephone number associated with the main telephone number.

When the different telephone number with voice print information belonging to the same person as the voice print information of the new telephone number is obtained from the call history storage portion 11 and cannot be obtained from the telephone directory storage portion 12, for example, an alert “A telephone call was made with *** (indicating the name of the telephone number newly registered in the telephone directory storage portion 12) on *** (indicating the date and time information stored in the call history) with a different telephone number not registered in the telephone directory” may be notified.

When the result of the search is that voice print information of the telephone number different from the new telephone number which voice print information belongs to the same person as the new voice print information is absent (step B7/No), the notification portion 25 notifies an alert to the effect that the different telephone number of the voice print information belonging to the same person as the voice print information of the new telephone number is absent (step B9). Examples of the alert include an alert such as “No call has been made with *** (indicating the name of the telephone number newly registered in the telephone directory storage portion 12) with the different telephone number”.

<Example of the Processing Operation Performed when an Additional Telephone Number is Registered in the Telephone Directory Storage Portion 12>

Next, referring to FIG. 10, an example of the processing operation performed when an additional telephone number is registered in the telephone directory storage portion 12 will be described.

When accepting an additional registration request for registering an additional telephone number in the telephone directory storage portion 12 (step CO, referring to the call history storage portion 11, the registration portion 24 performs search to check if the additional telephone number the request for additional registration of which is accepted is present in the call history storage portion 11 (step C2). The additional registration request occurs, for example, when the user operates the operation portion 50 or the like to perform a registration request operation for additionally registering a telephone number in the call history, in the telephone directory storage portion 12. Moreover, it occurs when the user inputs an additional telephone number by operating the operation portion 50 or the like and performs a registration request operation for additionally registering the inputted additional telephone number in the telephone directory storage portion 12.

When the additional telephone number the request for additional registration of which is accepted is absent in the call history storage portion 11 (step C3/No), the notification portion 25 notifies an alert to the effect that the voice print information corresponding to the additional telephone number is absent (step C4). Examples of the alert include an alert such as “No call has ever been made from the telephone number to be added”. This alert also occurs when a request for additional registration of a telephone number absent in the call history is made at step Cl. Even when the additional telephone number is absent in the call history storage portion 11, the user can register the additional telephone number in the telephone directory storage portion 12 by operating the operation portion 50. In this case, the additional telephone number is registered in a state of being associated with the addition target telephone number already stored in the telephone directory storage portion 12. In this case, the additional telephone number is registered in a state of being associated with the addition target telephone number.

When the additional telephone number the request for additional registration of which is accepted is present in the call history storage portion 11 (step C3/Yes), the voice print information associated with the additional telephone number is obtained from the call history storage portion 11 (step C5). When a plurality of pieces of voice print information associated with the additional telephone number are present, the pieces of voice print information may be obtained. Moreover, referring to the telephone directory storage portion 12, the voice print information associated with the addition target telephone number to which the additional telephone number is added is obtained from the telephone directory storage portion 12 (step C6). Then, the voice print information obtained from the call history storage portion 11 and the voice print information obtained from the telephone directory storage portion 12 are checked against each other, and it is determined whether these pieces of voice print information belong to the same person or not (step C7).

When the result of the check is that these pieces of voice print information belong to the same person (step C8/Yes), the additional telephone number is registered in the telephone directory storage portion 12 in a state of being associated with the addition target telephone number. Moreover, the voice print information obtained from the call history storage portion 11 is registered in the telephone directory storage portion 12 (step C9).

When the result of the check is that these pieces of voice print information do not belong to the same person (step C8/No), the notification portion 25 notifies an alert to the effect that the voice print information of the additional telephone number is different from the person of the voice print information of the addition target telephone number (step C10). Examples of the alert include an alert such as “The voice print information of the telephone number to be added is different from *** (indicating the name of the addition target telephone number stored in the telephone directory storage portion 12) of the addition target telephone number”.

When the user operates the operation portion 50 to perform a registration operation for registering the additional telephone number in the telephone directory storage portion 12 after the notification of the alert, it is determined that a telephone number is added (step C11/Yes), and the additional telephone number is registered in the telephone directory storage portion 12 in a state of being associated with the voice print information as a group of attention requiring telephone numbers that require attention (step C12).

Moreover, when the user operates the operation portion 50 to perform a registration cancellation operation not to register the additional telephone number in the telephone directory storage portion 12, it is determined that no telephone number is added (step C11/No), and the registration of the additional telephone number in the telephone directory storage portion 12 is canceled (step C13).

When the result of the check is that the pieces of voice print information do not belong to the same person (step C8/No), the additional telephone number may be automatically registered in the telephone directory storage portion 12 in a state of being associated with the voice print information as a group of attention requiring telephone numbers that require attention (step C12).

When a telephone number is registered as the attention requiring number group at step C12, prevention processing is performed.

Examples of the prevention processing include the following methods:

A telephone call is automatically made to the addition target telephone number.

The telephone number with the voice print information belonging to the same person as the voice print information associated with the addition target telephone number is extracted from the call history storage portion 11 or the telephone directory storage portion 12, and a telephone call is automatically made to the extracted telephone number.

A telephone call is automatically made to a prescribed telephone number.

When an alert is notified at step C4, it may be performed to register the additional telephone number in the telephone directory storage portion 12 as the attention requiring telephone number group that requires attention in a state of being associated with the voice print information (step C12) and perform the prevention processing.

Thereafter, when a telephone call comes from a telephone number the same as a telephone number registered in the attention requiring telephone number group, it is determined whether the voice print information of the opposite party of the telephone call corresponds to the voice print information associated with the addition target telephone number stored in the telephone directory storage portion 12 or to the voice print information associated with the attention requiring telephone number, and when it corresponds to the voice print information associated with the attention requiring telephone number, an alert to the effect that it is an attention requiring telephone number is notified. Examples of the alert include an alert such as “Is it OK that the opposite party is a person different from *** (indicating the name associated with the addition target telephone number)?”. When a telephone call comes from a telephone number the same as a telephone number registered in the attention requiring telephone number group, an alert to the effect that it comes from an attention requiring telephone number may be notified without the determination of the voice print information.

<Example of the Processing Operation Performed when a Telephone Number in the Telephone Directory Storage Portion 12 is Changed>

Next, referring to FIG. 11, an example of the processing operation performed when a telephone number in the telephone directory storage portion 12 is changed will be described.

When a change request to change a telephone number already stored in the telephone directory storage portion 12 to a different telephone number is accepted (step D1), referring to the call history storage portion 11, the registration portion 24 performs search to check if the telephone number after the change is present in the call history storage portion 11 (step D2). The change request occurs, for example, when the user operates the operation portion 50 or the like to perform a change request operation for changing the telephone number already stored in the telephone directory storage portion 12 to another telephone number in the call history. Moreover, it occurs when the user inputs the telephone number to which change is made, by operating the operation portion 50 or the like and performs a change request operation for changing the telephone number already stored in the telephone directory storage portion 12 to the different telephone number.

When the telephone number after the change is absent in the call history storage portion 11 (step D3/No), the notification portion 25 notifies an alert to the effect that the voice print information corresponding to the telephone number after the change is absent (step D4). Examples of the alert include an alert such as “No call has ever been made from the telephone number to which change is made”. This alert occurs when a change request for making a change to a different telephone number that is absent in the call history is performed at step D1.

When the telephone number after the change is present in the call history storage portion 11 (step D3/Yes), the voice print information associated with the telephone number after the change is obtained from the call history storage portion 11 (step D5). When a plurality of pieces of voice print information associated with the telephone number after the change are present, the piece of voice print information may be obtained. Moreover, referring to the telephone directory storage portion 12, the voice print information associated with the telephone number to be changed is obtained from the telephone directory storage portion 12 (step D6). Then, the voice print information obtained from the call history storage portion 11 and the voice print information obtained from the telephone directory storage portion 12 are checked against each other, and it is determined whether these pieces of voice print information belong to the same person or not (step D7).

When the result of the check is that these pieces of voice print information belong to the same person (step D8/Yes), the telephone number already stored in the telephone directory storage portion 12 is changed to the different telephone number. Moreover, the voice print information obtained from the call history storage portion 11 is registered in the telephone directory storage portion 12 in a state of being associated with the telephone number after the change (step D9).

When the result of the check is that these pieces of voice print information do not belong to the same person (step D8/No), the notification portion 25 notifies an alert to the effect that the voice print information of the telephone number after the change is different from the person of the voice print information of the telephone number to be changed (step D10). Examples of the alert include an alert such as “The voice print information of the telephone number to which change is made is different from *** (indicating the name of the telephone number to be changed stored in the telephone directory storage portion 12) of the telephone number to be changed”.

Moreover, when the result of the check is that these pieces of voice print information do not belong to the same person (step D8/No), the telephone number to be changed in the telephone directory storage portion 12 is not changed and the telephone number after the change is registered in the telephone directory storage portion 12 as an attention requiring telephone number group that requires attention in a state of being associated with the voice print information (step D11). Then, the prevention processing is performed.

Thereafter, when a telephone call comes from a telephone number the same as a telephone number registered in the attention requiring telephone number group, it is determined whether the voice print information of the opposite party of the telephone call corresponds to the voice print information associated with the addition target telephone number stored in the telephone directory storage portion 12 or to the voice print information associated with the attention requiring telephone number, and when it corresponds to the voice print information associated with the attention requiring telephone number, an alert to the effect that it is an attention requiring telephone number is notified. Examples of the alert include an alert such as “Is it OK that the opposite party is a person different from *** (indicating the name associated with the addition target telephone number”?. When a telephone call comes from a telephone number the same as a telephone number registered in the attention requiring telephone number group, an alert to the effect that it comes from an attention requiring telephone number may be notified without the determination of the voice print information.

The above-described telephone number changing processing shown in FIG. 11 may be previously set so that it cannot be performed.

By performing the above-described various processing operations, the telephone 100 of the present embodiment is suitable for the following case:

### <Case>

A swindler obtains a telephone number list of high school students or the like in some way. Then, referring to the list or the like, the swindler makes a telephone call to a son's parental home from a mobile telephone number, says to the called party (for example, a parent) at the parental home “This is *** (the name of the son). I've changed my mobile telephone number, so change the telephone number in the telephone directory”, and hangs up once. The called party recognizes the unknown mobile telephone number as his/her son's new mobile telephone number and updates the telephone directory. Thereafter, the swindler makes a telephone call again to the called party from the mobile telephone number, and says “This is *** (the name of the son). Please pay money into my bank account”.

In the above case, if the called party updates the telephone directory with the unknown mobile telephone number as the son's new mobile telephone number, a case is assumed where when a telephone call comes from the mobile telephone number thereafter, the son's name is displayed on the display or the like and the called party falsely recognizes the swindler as the son and pays money into the bank account.

According to the present embodiment, by pre-registering the voice print information in the telephone directory storage portion 12 in a state of being associated with the son's telephone number, even if a swindler impersonating the son makes a telephone call from an unknown mobile telephone number, falsely recognizing the swindler as the son can be prevented since the swindler's voice print information does not coincide with the son's voice print information. Moreover, when the son's voice print information is registered in the call history storage portion 11, even if a swindler impersonating the son makes a telephone call from an unknown mobile telephone number, falsely recognizing the swindler as the son can be prevented since the swindler's voice print information does not coincide with the son's voice print information.

### <Advantages and Effects of the Telephone 100 of the Present Embodiment>

As described above, in the telephone 100 of the present embodiment, the telephone number of the opposite party and the voice print information identifying the voice of the opposite party are stored in the call history storage portion 11 in a state of being associated with each other. Then, the telephone directory storage portion 12 is searched to check if a telephone number the same as the telephone number of the opposite party stored in the call history storage portion 11 is stored in the telephone directory storage portion 12. When a telephone number the same as the telephone number of the opposite party is stored in the telephone directory storage portion 12, the voice print information associated with the telephone number of the opposite party in the call history storage portion 11 is registered in a state of being associated with the same telephone number as the telephone number of the opposite party in the telephone directory storage portion 12. Thereby, the voice print information stored in the call history storage portion 11 can be efficiently stored in the telephone directory storage portion 12.

In the telephone 100 of the present embodiment, since the voice print information is stored in the call history storage portion 11 and the telephone directory storage portion 12, the opposite party can be identified by checking the voice print information of the opposite party against the voice print information stored in the call history storage portion 11 and the telephone directory storage portion 12. As a result, a swindle such as impersonation can be prevented.

The above-described embodiment which is a preferred embodiment of the present invention does not limit the scope of the invention only to the above-described embodiment and may be carried out with various modifications without departing from the gist of the invention.

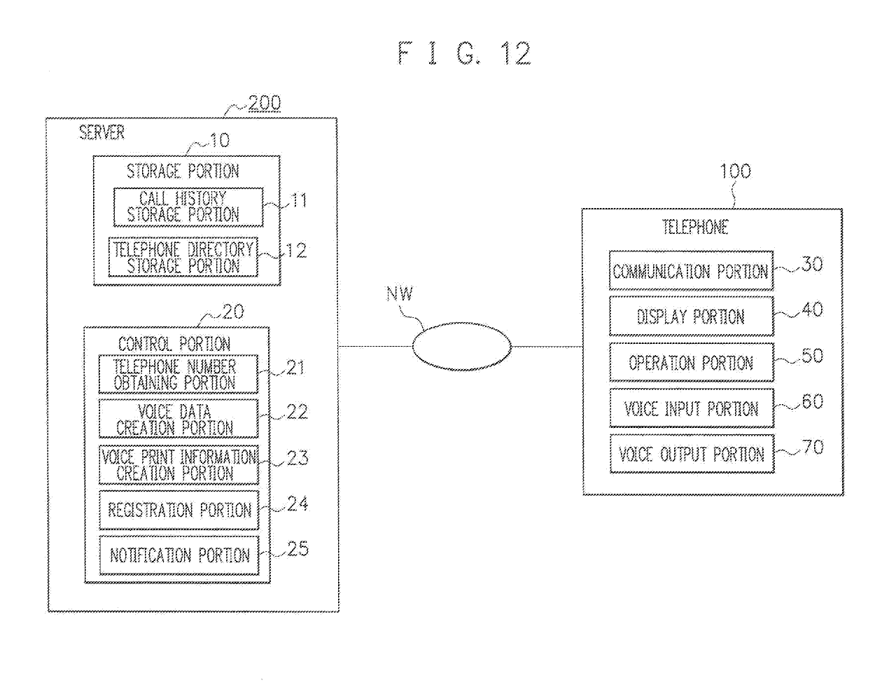

For example, in the above-described embodiment, as shown in FIG. 1, the telephone 100 has the telephone directory storage portion 12, and the telephone 100 functions as a telephone directory management apparatus. However, for example, as shown in FIG. 12, a structure may be adopted in which a server 200 of a network NW has the telephone directory storage portion 12 and the server 200 functions as a telephone directory management apparatus. In the case of the structure shown in FIG. 12, the various processing operations performed by the telephone 100 in the above-described embodiment are performed by the server 200, whereby voice print information can be registered in the telephone directory storage portion 12. Moreover, the server 200 can notify various alerts to the telephone 100. In the case of the structure shown in FIG. 12, the telephone 100 accesses the server 200 through the network NW and makes a telephone call with reference to the information stored in the telephone directory storage portion 12 of the server 200.

In the structure shown in FIG. 12, the server 200 has the call history storage portion 11 and the telephone directory storage portion 12, and the server 200 performs processing operations similar to those of the above-described embodiment. However, a structure may be adopted in which the telephone 100 has the call history storage portion 11, the server 200 has the telephone directory storage portion 12 and at least one of the telephone 100 and the server 200 performs processing operations similar to those of the above-described embodiment. For example, a structure may be adopted in which the telephone 100 performs the processing operation shown in FIG. 6 and the server 200 performs the processing operations shown in FIGS. 7 to 11. This enables a structure in which not the telephone 100 or the server 200 performs processing operations similar to those of the above-described embodiment alone but a system of the telephone 100 and the server 200 performs processing operations similar to those of the above-described embodiment. As a result, the telephone 100 and the server 200 can function as a telephone directory management system.

Moreover, as the voice print information stored in both the call history storage portion 11 and the telephone directory storage portion 12 in the above-described embodiment, one voice print information file may be shared in a logically associated state between the storage portions 11 and 12, or one voice print information file may be stored in each of the storage portions 11 and 12. However, in the case where one voice print information file is shared between the storage portions 11 and 12, when a prescribed time, or a prescribed number of stored files or storage capacity is exceeded and an old call history is deleted in the call history storage portion 11, the voice print information stored also in the telephone directory storage portion 12 is not deleted.

Moreover, in the above-described embodiment, the voice print information stored in the call history storage portion 11 is registered in the telephone directory storage portion 12 and the voice print information check is performed by using the voice print information. For this reason, the voice data in the call history storage portion 11 may be deleted after voice print information is created. However, human voices can be uniquely identified even by voice data. Therefore, it is possible to register the voice data stored in the call history storage portion 11, in the telephone directory storage portion 12 and perform the check by using the voice data.

Moreover, the control operations by the portions constituting the telephone 100 of the above-described embodiment may be executed by using hardware, software or a structure composed of these.

When software is used for executing processing, it is possible to install a program recording the processing sequence on a memory in a computer incorporated in dedicate hardware and execute it. Alternatively, it is possible to install the program on a memory in a general-purpose computer capable of various kinds of processing and execute it.

For example, the program may be pre-recorded on a hard disk or a ROM (read only memory) as a recording medium. Alternatively, the program may be temporarily or permanently stored (recorded) on a removable recording medium. Such a removable recording medium can be provided as so-called packaged software. Examples of the removable recording medium include various kinds of recording media such as a magnetic disk and a semiconductor memory.

The program is installed from a removable recording medium as mentioned above into a computer. Moreover, it is wirelessly transferred from a download site to a computer. Moreover, it is transferred to a computer by cable through a network.

The portions constituting the telephone 100 of the above-described embodiment are not limited only to ones that execute processing in chronological order according to the processing operations described in the above-described embodiment. For example, they may be structured so as to execute processing in parallel or individually according to the processing capability of the device executing the processing or as required.

The whole or part of the exemplary embodiments disclosed above can be described as, but not limited to, the following supplementary notes.
(Supplementary note 1) A telephone directory management apparatus having telephone directory storage means for storing a telephone number, the apparatus comprising:

registration means for searching the telephone directory storage means to check if a telephone number the same as a telephone number of an opposite party stored in call history storage means for storing the telephone number of the opposite party and voice information for identifying a voice of the opposite party in an associated state is stored in the telephone directory storage means and when a telephone number the same as the telephone number of the opposite party is stored in the telephone directory storage means, registering the voice information associated with the telephone number of the opposite party in the call history storage means in a state of being associated with the telephone number the same as the telephone number of the opposite party in the telephone directory storage means.
(Supplementary note 2) The telephone directory management apparatus according to Supplementary note 1,

wherein when voice information has already been associated with the telephone number the same as the telephone number of the opposite party in the telephone directory storage means, the voice information already associated in the telephone directory storage means and voice information newly registered in the telephone directory storage means are checked against each other and a result of the check is notified.
(Supplementary note 3) The telephone directory management apparatus according to Supplementary note 2,

wherein when the result of the check is that these pieces of voice information belong to different persons, respectively, the registration means registers the newly registered voice information in the telephone directory storage means in a group different from that of the already associated voice information.
(Supplementary note 4) The telephone directory management apparatus according to Supplementary note 2 or 3,

wherein when the result of the check is that these pieces of voice information belong to the same person, the registration means registers the newly registered voice information in the telephone directory storage means in the same group as that of the already associated voice information.
(Supplementary note 5) The telephone directory management apparatus according to any one of Supplementary notes 1 to 4,

wherein when a telephone number the same as the telephone number of the opposite party is not stored in the telephone directory storage means, the registration means performs search to check if another telephone number the same as the telephone number of the opposite party is stored in the call history storage means as a past call history, and when another telephone number the same as the telephone number of the opposite party is stored in the call history storage means, the registration means checks pieces of voice information associated with these telephone numbers against each other and notifies a result of the check.
(Supplementary note 6) The telephone directory management apparatus according to any one of Supplementary notes 1 to 5,

wherein when a new telephone number is registered in the telephone directory storage means, the registration means performs search to check if a telephone number the same as the new telephone number is stored in the call history storage means, and when a telephone number the same as the new telephone number is stored in the call history storage means, the registration means registers voice information associated with the telephone number the same as the new telephone number in the call history storage means, in the telephone directory storage means in a state of being associated with the new telephone number.
(Supplementary note 7) The telephone directory management apparatus according to Supplementary note 6,

wherein the registration means searches at least one of the call history storage means and the telephone directory storage means to check if voice information determined to belong to the same person as the voice information associated with the new telephone number is associated with a telephone number different from the new telephone number, and notifies a result of the check.
(Supplementary note 8) The telephone directory management apparatus according to Supplementary note 7,

wherein when the result of the check is that the voice information determined to belong to the same person is associated with the different telephone number, the registration means associates the new telephone number with the different telephone number.
(Supplementary note 9) The telephone directory management apparatus according to any one of Supplementary notes 1 to 8,

wherein when an additional telephone number is additionally registered to a telephone number stored in the telephone directory storage means, the registration means performs search to check if a telephone number the same as the additional telephone number is stored in the call history storage means,

when a telephone number the same as the additional telephone number is stored in the call history storage means, the registration means checks against each other voice information associated with the telephone number the same as the additional telephone number in the call history storage means and voice information associated with the telephone number to which the additional telephone number is additionally registered in the telephone directory storage means, and

when it is determined that these pieces of voice information belong to different persons, respectively, the registration means registers the additional telephone number in the telephone directory storage means as a group of an attention requiring telephone number that requires attention and registers the voice information associated with the telephone number the same as the additional telephone number in the telephone directory storage means.
(Supplementary note 10) The telephone directory management apparatus according to any one of Supplementary notes 1 to 9,

wherein when a telephone number stored in the telephone directory storage means is changed, the registration means performs search to check if a telephone number the same as a telephone number after the change is stored in the call history storage means,

when a telephone number the same as the telephone number after the change is stored in the call history storage means, the registration means checks against each other voice information associated with the telephone number the same as the telephone number after the change in the call history storage means and voice information associated with the telephone number to be changed in the telephone directory storage means, and

when it is determined that these pieces of voice information belong to different persons, respectively, without changing the telephone number to be changed, to the telephone number after the change, the registration means registers the telephone number after the change in the telephone directory storage means as an attention requiring telephone number group that requires attention, and registers the voice information associated with the telephone number the same as the telephone number after the change in the telephone directory storage means.
(Supplementary note 11) The telephone directory management apparatus according to Supplementary note 9 or 10,

comprising notification means for, when a telephone call comes from a telephone number the same as the telephone number registered in the telephone directory storage means as the attention requiring telephone number group, providing a notification to the effect that the telephone call comes from an attention requiring telephone number.
(Supplementary note 12) A telephone directory management system having telephone directory storage means for storing a telephone number, the system comprising:

call history storage means for storing a telephone number of an opposite party and voice information for identifying a voice of the opposite party in an associated state; and

registration means for searching the telephone directory storage means to check if a telephone number the same as the telephone number of the opposite party stored in the call history storage means is stored in the telephone directory storage means, and when a telephone number the same as the telephone number of the opposite party is stored in the telephone directory storage means, registering the voice information associated with the telephone number of the opposite party in the call history storage means in a state of being associated with the telephone number the same as the telephone number of the opposite party in the telephone directory storage means.
(Supplementary note 13) A telephone directory management method of a telephone directory management apparatus having telephone directory storage means for storing a telephone number, the method comprising a registration step of searching the telephone directory storage means to check if a telephone number the same as a telephone number of an opposite party stored in call history storage means for storing the telephone number of the opposite party and voice information for identifying a voice of the opposite party in an associated state is stored in the telephone directory storage means and when a telephone number the same as the telephone number of the opposite party is stored in the telephone directory storage means, registering the voice information associated with the telephone number of the opposite party in the call history storage means in a state of being associated with the telephone number the same as the telephone number of the opposite party in the telephone directory storage means.
(Supplementary note 14) A recording medium recording a program for causing a computer having telephone directory storage means for storing a telephone number is caused to execute, the program causing the computer to execute registration processing of searching the telephone directory storage means to check if a telephone number the same as a telephone number of an opposite party stored in call history storage means for storing the telephone number of the opposite party and voice information for identifying a voice of the opposite party in an associated state is stored in the telephone directory storage means, and when a telephone number the same as the telephone number of the opposite party is stored in the telephone directory storage means, registering the voice information associated with the telephone number of the opposite party in the call history storage means in a state of being associated with the telephone number the same as the telephone number of the opposite party in the telephone directory storage means.

### DESCRIPTION OF REFERENCE NUMERALS

100 Telephone
10 Storage portion
11 Call history storage portion
12 Telephone directory storage portion
20 Control portion
21 Telephone number obtaining portion
22 Voice data creation portion
23 Voice print information creation portion
24 Registration portion
25 Notification portion
30 Call making portion
40 Display portion
50 Operation portion
60 Voice input portion
70 Voice output portion
200 Server
NW Network

What is claimed is:

1. A telephone directory management apparatus having telephone directory storage means for storing a telephone number, the apparatus comprising:
registration means for searching the telephone directory storage means to cheek if a telephone number the same as a telephone number of an opposite party stored in call history storage means for storing the telephone number of the opposite party and voice information for identifying a voice of the opposite party in an associated state is stored in the telephone directory storage means and when a telephone number the same as the telephone number of the opposite party is stored in the telephone directory storage means, registering the voice information associated with the telephone number of the opposite party in the call history storage means in a state of being associated with the telephone number the same as the telephone number of the opposite party in the telephone directory storage means.

2. The telephone directory management apparatus according to claim 1,
wherein when voice information has already been associated with the telephone number the same as the telephone number of the opposite party in the telephone directory storage means, the voice information, already associated in the telephone directory storage means and voice information newly registered in the telephone directory storage means are checked against each other and a result of the check is notified.

3. The telephone directory management apparatus according to claim 2,
wherein when the result of the check is that these pieces of voice information belong to different persons, respectively, the registration means registers the newly registered voice information in the telephone directory storage means in a group different from that of the already associated voice information.

4. The telephone directory management apparatus according to claim 2,
wherein when the result of the check is that these pieces of voice information belong to the same person, the registration means registers the newly registered voice information in the telephone directory storage means in the same group as that of the already associated voice information.

5. The telephone directory management apparatus according to claim 1,
wherein when a telephone number the same as the telephone number of the opposite party is not stored in the telephone directory storage means, the registration means performs search to check if another telephone number the same as the telephone number of the opposite party is stored in the call history storage means as a past call history, and when another telephone number the same as the telephone number of the opposite party is stored in the call history storage means, the registration means checks pieces of voice information associated with these telephone numbers against each other and, notifies a result of the check.

6. The telephone directory management apparatus according to claim 1,
wherein when a new telephone number is registered in the telephone directory storage means, the registration means performs search to check if a telephone number the same as the new telephone number is stored in the call history storage means, and when a telephone number the same as the new telephone number is stored in the call history storage means, the registration means registers voice information associated with the telephone number the same as the new telephone number in the call history storage means, in the telephone directory storage means in a state of being associated with the new telephone number.

7. The telephone directory management apparatus according to claim 6,
wherein the registration means searches at least one of the call history storage means and the telephone directory storage means to check if voice information determined to belong to the same person as the voice information associated with the new telephone number is associated with a telephone number different from the new telephone number, and notifies a result of the check.

8. The telephone directory management apparatus according to claim 7,
wherein when the result of the check is that the voice information determined to belong to the same person is associated with the different telephone number, the registration means associates the new telephone number with the different telephone number.

9. The telephone directory management apparatus according to claim 1,
wherein when an additional telephone number is additionally registered to a telephone number stored in the telephone directory storage means, the registration means performs search to check if a telephone number the same as the additional telephone number is stored in the call history storage means,
when a telephone number the same as the additional telephone number is stored in the call history storage means, the registration means cheeks against, each other voice information associated with the telephone number the same as the additional telephone number in the call history storage means and voice information associated with the telephone number to which the additional telephone number is additionally registered in the telephone directory storage means, and
when it is determined that these pieces of voice information belong to different persons, respectively, the registration means registers the additional telephone number in the telephone directory storage means as it group of an attention requiring telephone number that requires attention and registers the voice information associated with the telephone number the same as the additional telephone number in the telephone directory storage means.

10. The telephone directory management apparatus according to claim 1,
wherein when a telephone number stored in the telephone directory storage means is changed, the registration means performs search to check it a telephone number the same as a telephone number after the change is stored in the call history storage means,
when a telephone number the same as the telephone number after the change is stored in the call history storage means, the registration means checks against each other voice information associated with the telephone number the same as the telephone number after the change in the call history storage means and voice information associated with the telephone number to be changed in the telephone directory storage means, and.
when it is determined that these pieces of voice information belong to different persons, respectively, without changing the telephone number to be changed, to the telephone number after the change, the registration means registers the telephone number after the change in the telephone directory storage means as an attention requiring telephone number group that requires attention, and registers the voice information associated, with the telephone number the same as the telephone number after the change in the telephone directory storage means.

11. The telephone directory management apparatus according to claim 9,
comprising notification means for, when a telephone call come from a telephone number the same as the telephone number registered in the telephone directory storage means as the attention requiring telephone number group, providing a notification to the effect that the telephone call comes from an attention requiring telephone number.

12. A telephone directory management system having telephone directory storage means for storing a telephone number, the system comprising:
call history storage means for storing a telephone number of an opposite party and voice information for identifying a voice of the opposite party in an associated state; and
registration means for searching the telephone directory storage means to check if a telephone number the same as the telephone number of the opposite party stored in the call history storage means is stored in the telephone directory storage means, and when a telephone number the same as the telephone number of the opposite party is stored in the telephone directory storage means, registering the voice information associated with the telephone number of the opposite party in the cad history storage means in a state of being associated with the telephone number the same as the telephone number of the opposite party in the telephone directory storage means.

13. A telephone directory management method of a telephone directory management apparatus having telephone directory storage means for storing a telephone number, the method comprising a registration step of searching the telephone directory storage means to check if a telephone number the same as a telephone number of an opposite party stored in call history storage means for storing the telephone number of the opposite party and voice information for identifying a voice of the opposite party in an associated state is stored in the telephone directory storage means and when a telephone number the same as the telephone number of the opposite party is stored in the telephone directory storage means, registering the voice information associated with the telephone number of the opposite party in the call history storage means in a state of being associated with the telephone number the same as the telephone number of the opposite party in the telephone directory storage means.
